(19) United States
(12) Patent Application Publication
(10) Pub. No.: US 2011/0190945 A1
(43) Pub. Date: Aug. 4, 2011

(54) AIR-CONDITIONING CONTROL APPARATUS

(75) Inventors: Katsuji Yoshii, Tokyo-to (JP); Junya Nakasone, Kiryu-shi (JP); Koichi Yamana, Itami-shi (JP)

(73) Assignee: SANYO ELECTRIC CO., LTD., Osaka (JP)

(21) Appl. No.: 13/017,822

(22) Filed: Jan. 31, 2011

(30) Foreign Application Priority Data
Jan. 29, 2010 (JP) 2010-019531

(51) Int. Cl. G05D 23/00

(52) U.S. Cl. 700/277

(57) ABSTRACT

An air-conditioning-control apparatus of an air-conditioning system, which includes a plurality of air conditioners respectively provided in a plurality of sections obtained by virtually dividing a space to be air-conditioned, the conditioners configured to set the sections at desired temperatures, respectively, includes: a people-detection unit to detect presence or absence of a person in each of the sections; a memory to store temperature-adjustment data, for adjusting a setting temperature in each of the air conditioners, which is of a plurality of types each in accordance with a pattern of presence or absence of a person in each of the sections; and an adjustment unit to select the temperature-adjustment data of a pattern corresponding to a detection result of the people-detection unit from among the temperature-adjustment data of a plurality of types, and adjust the setting temperature of each of the air conditioners in accordance with the selected temperature-adjustment data.

### CROSS-REFERENCE TO RELATED APPLICATION

This application claims the benefit of priority to Japanese Patent Application No. 2010-019531, filed Jan. 29, 2010, of which full contents are incorporated herein by reference.

### BACKGROUND OF THE INVENTION

1. Field of the Invention

The present invention relates to an air-conditioning control apparatus.

2. Description of the Related Art

Such an air conditioner is known that a signal from an image pickup device is processed so that the presence or absence of a human in each control area is determined, and a target temperature of a limit, beyond which people feel uncomfortable, is set in an area where no person is present, while a target temperature lower than a comfortable temperature is set with an air-blow speed being increased to an allowable limit in an area where a person is present (See Japanese Patent No. 3848786, for example).

In the above-described air conditioner, control needs to be changed in detail each time an area where a person is present is changed. Here, if the control is changed by each calculation every time, processing becomes complicated, so that efficiency is lowered.

The present invention is made considering the above circumstances, and has an object to improve efficiency in changing the detail of control.

### SUMMARY OF THE INVENTION

An air-conditioning control apparatus of an air-conditioning system according to an aspect of the present invention, which includes a plurality of air conditioners respectively provided in a plurality of sections obtained by virtually dividing a space to be air-conditioned, the plurality of air conditioners configured to set the plurality of sections at desired temperatures, respectively, includes: a people detection unit configured to detect presence or absence of a person in each of the plurality of sections; a memory configured to store temperature adjustment data for adjusting a setting temperature in each of the plurality of air conditioners, the temperature adjustment data being of a plurality of types each in accordance with a pattern of presence or absence of a person in each of the plurality of sections; and an adjustment unit configured to select the temperature adjustment data of a pattern corresponding to a detection result of the people detection unit from among the temperature adjustment data of a plurality of types, and adjust the setting temperature of each of the plurality of air conditioners in accordance with the selected temperature adjustment data.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of an electric equipment management system;

FIG. 2 is a diagram schematically illustrating an arrangement of electric equipment in an indoor space;

FIG. 3A is a block diagram illustrating a configuration of a host computer;

FIG. 3B is a diagram illustrating a storage area included in memory;

FIG. 4A is a block diagram illustrating a configuration of an image processing computer;

FIG. 4B is a diagram illustrating a storage area included in memory;

FIG. 5A is a block diagram illustrating a configuration of a control system included in an air conditioner;

FIG. 5B is a diagram illustrating a storage area included in memory;

FIG. 6A is a block diagram illustrating a configuration of a control system included in a fluorescent lamp unit;

FIG. 6B is a diagram illustrating a storage area included in memory;

FIG. 7 is a diagram illustrating a control pattern example (A);

FIG. 8 is a diagram illustrating a control pattern example (B);

FIG. 9 is a diagram illustrating a control pattern example (C);

FIG. 10 is a diagram illustrating a control pattern example (D);

FIG. 11 is a diagram illustrating a control pattern example (E);

FIG. 12 is a diagram illustrating a control pattern example (F); and

FIG. 13 is a flowchart illustrating an operation.

### DETAILED DESCRIPTION OF THE INVENTION

At least the following details will become apparent from descriptions of this specification and of the accompanying drawings.

### <System Configuration>

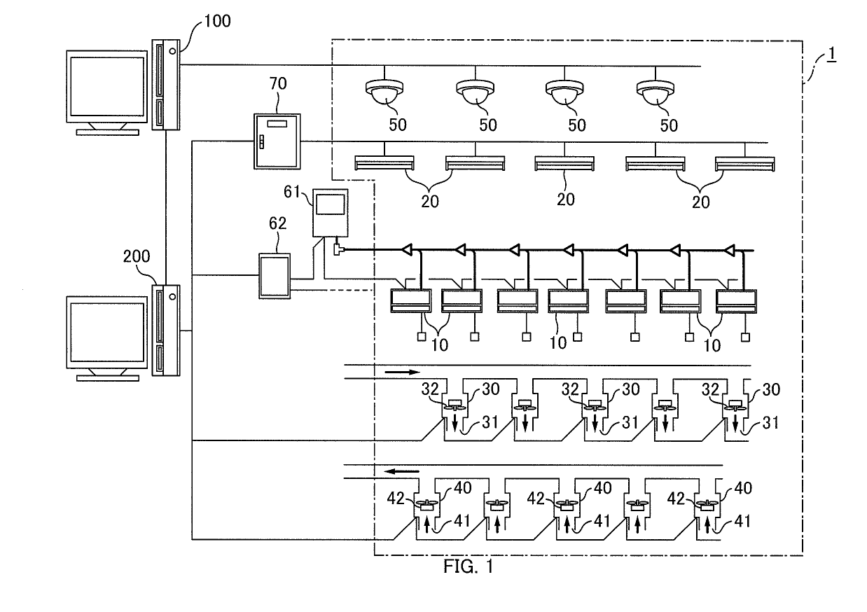

An electric equipment management system (air-conditioning system, indoor ventilation system) according to an embodiment of the present invention will hereinafter be described. As shown in FIG. 1, this electric equipment management system manages operations of a plurality of types of electric equipment installed in an indoor space 1 (space to be air-conditioned, space to be ventilated) of a building. The electric equipment installed in the indoor space 1 include a plurality of air conditioners 10, a plurality of fluorescent lamp units 20 (illumination units), a plurality of air intake devices 30, a plurality of exhaust devices 40, and a plurality of cameras 50, for example. Further, the building is provided with an outdoor unit 61 and a communication adaptor 62 for the air conditioners 10, an illumination interface 70 for the florescent lamp units 20, a host computer 100, and an image processing computer 200.

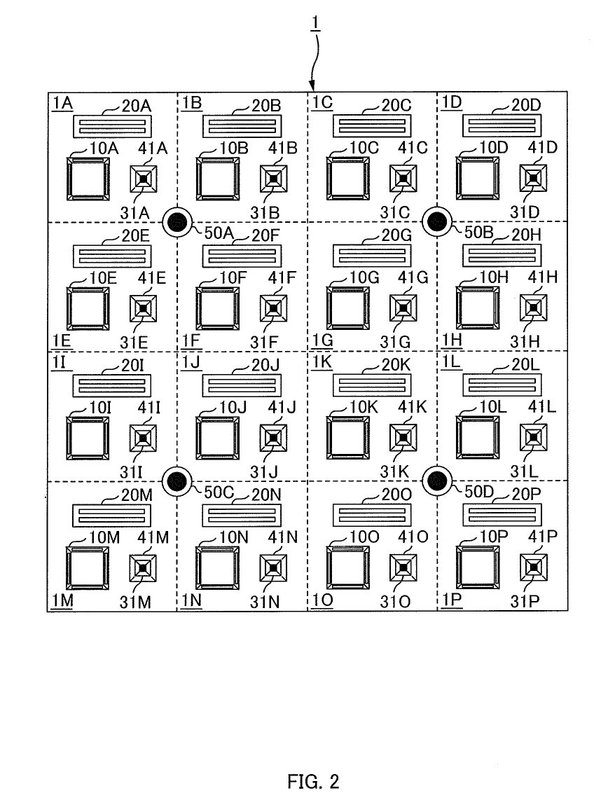

In this electric equipment management system, the indoor space 1 is virtually divided into a plurality of sections, and air conditioning and ventilation are controlled in each section. As shown in FIG. 2, in an embodiment of the present invention, the indoor space 1 is divided horizontally in a grid manner. For convenience, a description will be given, as an example, of the indoor space 1 including 16 rectangular sections 1A to 1P which are obtained by vertically dividing the space into four and by horizontally dividing into four.

The air conditioners 10 are arranged at different spots in the indoor space 1. In an embodiment according to the present invention, 16 air conditioners 10A to 10P are provided in each of the 16 sections 1A to 1P, respectively. Then, the air conditioners 10A to 10P are operated so as to set the corresponding sections 1A to 1P at setting temperatures, respectively.

The fluorescent lamp units 20 are also provided in the plurality of sections 1A to 1P, respectively. In an embodiment of the present invention, the 16 fluorescent lamp units 20A to 20P are provided in the sections 1A to 1P, respectively. And each of the fluorescent lamp units 20A to 20P can be adjusted in brightness, so that each of the sections 1A to 1P can be adjusted in brightness.

The intake devices 30 and the exhaust devices 40 are also provided in the plurality of sections 1A to 1P, respectively. In an embodiment of the present invention, a plurality of inlets 31A to 31P and outlets 41A to 41P are provided in the sections 1A to 1P, respectively. The rotation speed of an intake motor 32 is controlled, so that the intake devices 30 can individually change the amount of outside air to be taken into the indoor space 1 through each of the inlets 31A to 31P. Similarly, the rotation speed of an exhaust motor 42 is controlled, the exhaust devices 40 can individually change the amount of exhausted from the indoor space 1 to the outside through each of the outlets 41A to 41P. The intake motor 32 and the exhaust motor 42 are individually changed in rotation speed by an intake/exhaust change signal outputted from the host computer 100. That is, the host computer 100 can control an intake amount by the intake devices 30 and an exhaust amount by the exhaust devices 40.

The camera 50 is used for taking a photograph of the indoor space 1. In an embodiment of the present invention, as shown in FIG. 2, four cameras 50A to 50D are provided in the indoor space 1. That is, the camera 50A is arranged at a position at which the four sections 1A, 1B, 1E and 1F have contact one another, and the camera 50B is arranged at a position at which the sections 1C, 1D, 1G, and 1H have contact one another. Similarly, the camera 50C is arranged at a position at which the sections 1I, 1J, 1M, and 1N have contact one another, and the camera 50D is arranged at a position at which the sections 1K, 1L, 1O, and 1P have contact one another.

In such units as described above, a group of the camera 50, the image processing computer 200 and the host computer 100 corresponds to an air-conditioning control apparatus configured to control air conditioning in the indoor space 1. It also corresponds to a ventilation control apparatus configured to control ventilation in the indoor space 1. Also, a group of the camera 50 and the image processing computer 200 corresponds to a people detection unit (human detection unit) configured to detect the presence or absence of a person (people) in the indoor space 1 and a people count detection unit configured to determine the number of people who are present in the indoor space 1. Further, the host computer 100 corresponds to an adjustment unit (control unit) configured to adjust a setting temperature of each of the air conditioners 10 in accordance with the results of detecting people by the cameras 50 and the image processing computer 200, set intake/exhaust amounts for each of the intake devices 30 and the exhaust devices 40, and sets illuminance of each of the fluorescent lamp units 20.

### <Electrical Configuration>

Subsequently, an electrical configuration of the electric equipment management system will be described.

### <Host Computer 100>

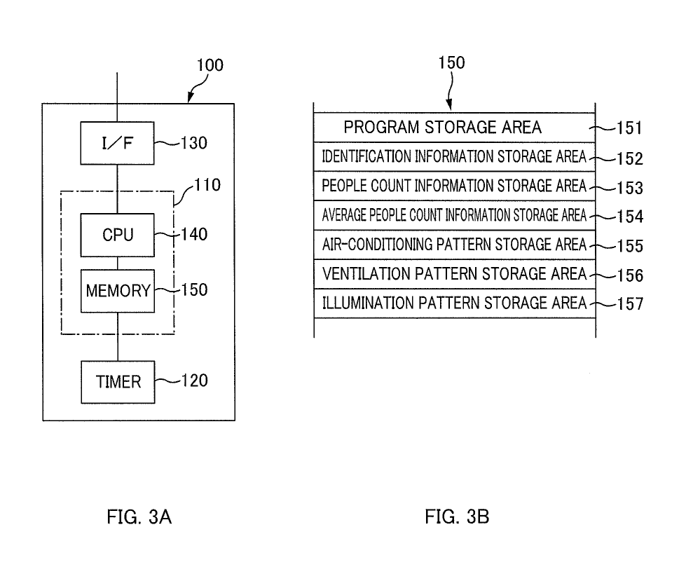

As shown in FIG. 3A, the host computer 100 includes a control unit 110, a timer 120, and an interface 130 for communication.

The control unit 110 includes a CPU 140 and a memory 150, and the CPU 140 executes a program stored in the memory 150, so as to realize various control operations. For example, “signals for change” for changing settings are outputted to the air conditioner 10, the intake motor 32, the exhaust motor 42, and the fluorescent lamp unit 20. The timer 120 outputs time information which is required for control. For example, the timer 120 outputs timing information that specifies operation timing at each predetermined period of time and outputs current time information that indicates current time. The interface 130 for communication controls communication in the host computer 100.

A part of areas of the memory 150 are used, as shown in FIG. 3B, as a program storage area 151, an identification information storage area 152, a people count information storage area 153, an average people count storage area 154, an air-conditioning pattern storage area 155, a ventilation pattern storage area 156, and an illumination pattern storage area 157.

In the program storage area 151, a program to be read and executed by the CPU 140 is stored.

In the identification information storage area 152, identification information is stored, which indicates the electric equipment capable of communicating with the host computer 100. For example, unique identification information is stored, which indicates each piece of the equipment with respect to the air conditioners 10A to 10P and the fluorescent lamp units 20A to 20P. Therefore, the host computer 100 can recognize from which piece of the electric equipment the received information is transmitted by checking the identification information contained in the received information against the identification information stored in the identification information storage area 152.

In the people count information storage area 153, people count information (which will be described later) is stored, which is transmitted from the image processing computer 200 at predetermined intervals. In an embodiment of the present invention, the people count information indicating the number of people in each section at the time is transmitted every one minute. And such people count information is stored in plural sets from the latest information to the information of three minutes before (predetermined time before).

In the average people count information storage area 154, information of the average number of people in a predetermined time is stored. In an embodiment of the present invention, with reference to three sets of people count information stored in the people count information storage area 153, an average value thereof is calculated, so that the number of people in each of the sections 1A to 1P in the past three minutes is calculated. As such, if the average value of the past three minutes is calculated and is used for control, the number of people who are continuously present in each of the sections 1A to 1P can be easily grasped, and such a malfunction that the control is performed in an excessively particular manner can be suppressed.

In the air-conditioning pattern storage area 155, patterns for air conditioning for adjusting a setting temperature in each of the air conditioners 10A to 10P (temperature adjustment data) are stored in a plurality of types each in accordance with patterns of the presence or absence of people in each section. Such air-conditioning pattern includes: data for cooling for adjusting the setting temperature so that a section without a person, where a person is not detected, among the plurality of sections 1A to 1P is set at a temperature higher than a temperature in a section with a person, where a person is detected; and data for heating for adjusting the setting temperature so that the section without a person is set at a temperature lower than the temperature of the section with a person. The air-conditioning pattern will be described later in detail.

In the ventilation pattern storage area 156, stored are patterns for ventilation for setting an intake amount of the outside air or an exhaust amount of the indoor air for each of the plurality of inlets 31A to 31P and the outlets 41A to 41P (intake amount data, exhaust amount data). Such ventilation pattern is to make adjustment so that the amount of the outside air to be taken in through the inlet 31 far from the section with a person becomes greater than the amount of the outside air taken in through the inlet 31 close to the section with a person. Also, the ventilation pattern is to make adjustment so that the amount of the indoor air exhausted through the outlet 41 far from the section with a person becomes greater than the amount of the indoor air exhausted through the outlet 41 close to the section with a person. And the ventilation patterns are also stored in a plurality of types each in accordance with the pattern of the presence or absence of a person in each section. The ventilation pattern will also be described later in detail.

In the illumination pattern storage area 157, patterns for illumination for adjusting illuminance in each of the fluorescent lamp units 20A to 20P (illuminance adjustment data) are stored in a plurality of types each in accordance with the pattern of the presence or absence of a person in each section. Such illumination pattern is to make adjustment so that the illuminance of the fluorescent lamp unit 20 far from the section with a person is set less than the illuminance of the fluorescent lamp unit 20 close to the section with a person. The illumination pattern will also be described later in detail.

### <Image Processing Computer 200>

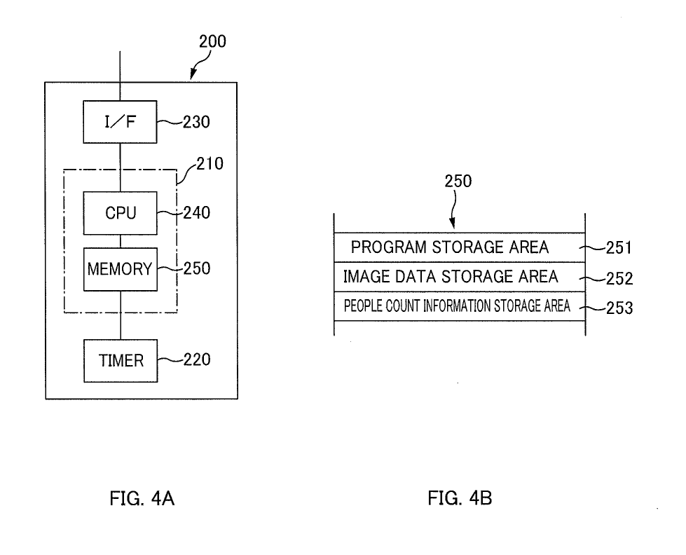

As shown in FIG. 4A, the image processing computer 200 includes a control unit 210, a timer 220, and an interface 230 for communication.

The control unit 210 includes a CPU 240 and a memory 250, and the CPU 240 executes a program stored in the memory 250, so that various control operations are realized. For example, the control unit 210 performs processing of determining the number of people in each section from image data picked up by the camera 50 or processing of transmitting the people count information indicating the number of people in each section to the host computer 100. The timer 220 outputs time information (timing information, current time information) which is required for control. The interface 230 for communication controls communication in the host computer 100.

A part of areas in the memory 250 are used, as shown in FIG. 4B, as a program storage area 251, an image data storage area 252, and a people count information storage area 253.

In the program storage area 251, a program to be read and executed by the CPU 240 is stored. In the image data storage area 252, the image data picked up by each of the cameras 50A to 50D is stored. The image data stored in the image data storage area 252 is referred to when the control unit 210 performs the processing of determining the number of people in each section. In the people count information storage area 253, the people count information obtained by the control unit 210 is stored.

### <Air Conditioner 10>

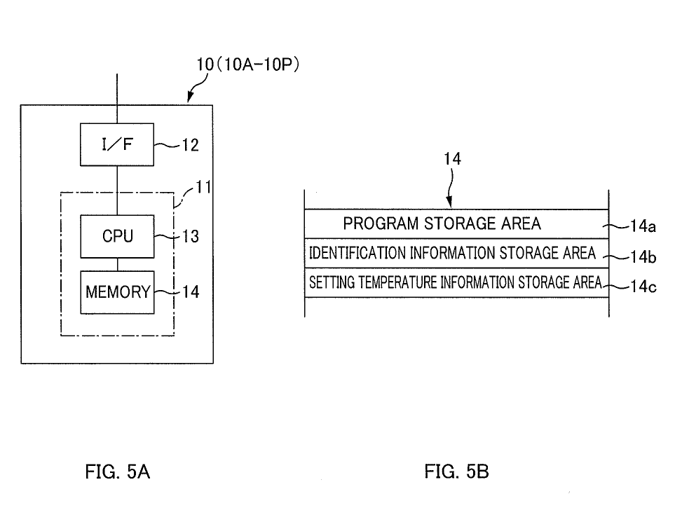

As shown in FIG. 5A, the air conditioner 10 includes a control unit 11 and an interface 12 for communication. The control unit 11 is a unit that includes a CPU 13 and a memory 14 and is executes various control operations. The interface for communication controls communication in the air conditioner 10.

A part of areas of the memory 14 are used, as shown in FIG. 5B, as a program storage area 14a, an identification information storage area 14b, and a setting temperature information storage area 14c.

In the program storage area 14a, a program to be read and executed by the CPU 13 is stored. In the identification information storage area 14b, unique identification information indicating the air conditioner 10 is stored. Such identification information is used when the air conditioner 10 transmits/receives information. For example, when receiving a temperature-change signal for changing a setting temperature, the air conditioner 10 receives the temperature-change signal including the corresponding identification information. As a result, the air conditioner 10 can select and receive a temperature-change signal to be targeted when receiving the temperature-change signal. In the setting temperature information storage area 14c, setting temperature information indicating information such as a setting temperature and an air volume in the air conditioner 10 is stored. The control unit 11 refers to the setting temperature information to recognize the setting temperature and the air volume, and makes temperature adjustment in the corresponding section. Therefore, the temperature of the corresponding section can be adjusted by rewriting the contents of the setting temperature information.

### <Fluorescent Lamp Unit 20>

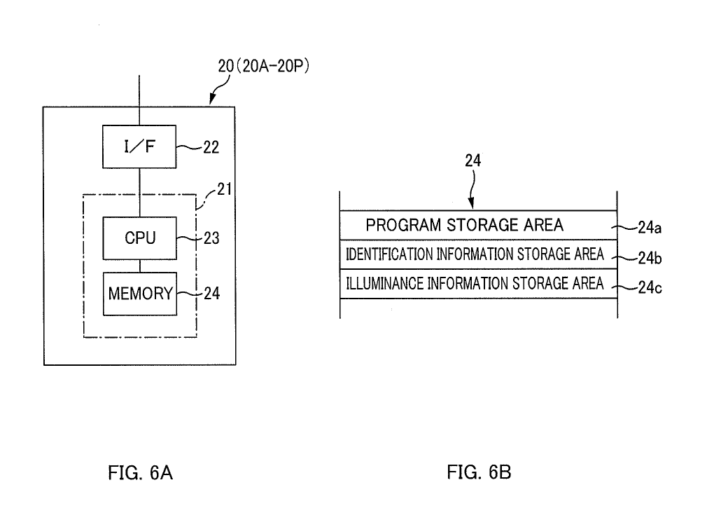

As shown in FIG. 6A, the fluorescent lamp unit 20 includes a control unit 21 and an interface 22 for communication. The control unit 21 is a unit that includes a CPU 23 and a memory 24 and executes various control operations. The interface 22 for communication controls communication in the fluorescent lamp unit 20.

A part of areas of the memory 24 are used, as shown in FIG. 6B, as a program storage area 24a, an identification information storage area 24b, and an illuminance information storage area 24c. In the program storage area 24a, a program to be read and executed by the CPU 23 is stored. In the identification information storage area 24b, unique identification information indicating the fluorescent lamp unit 20 is stored. Such identification information is used when the fluorescent lamp unit 20 transmits/receives information. For example, when receiving an illuminance-change signal for changing illuminance in the fluorescent lamp unit 20, the fluorescent lamp unit 20 receives the illuminance-change signal including the corresponding identification information. As a result, the fluorescent lamp unit 20 can select and receive illuminance control information which is required when receiving the illuminance-change signal. In the illuminance information storage area 24c, illuminance information indicating illuminance in the fluorescent lamp unit 20 is stored. The control unit 21 refers to the illuminance information to recognize a setting value of illuminance, and executes control for the fluorescent lamp. Therefore, the illuminance of the fluorescent lamp unit 20 can be changed by rewriting the contents of the illuminance information.

### <Specific Examples of Patterns>

Subsequently, a plurality of types of control patterns which are stored in the memory of the host computer 100, that is, the air-conditioning pattern, ventilation pattern, and illumination pattern will be described in detail. As described above, the air-conditioning pattern is to adjust a setting temperature in each of the air conditioners 10A to 10P in accordance with the patterns of the presence or absence of a person in each section. Also, the ventilation pattern is to set an intake amount of the outside air or an exhaust amount of the indoor air in each of the plurality of inlets 31A to 31P and the outlets 41A to 41P in accordance with the pattern of the number of people in each section. In other words, it is to set a rotation speed of each intake motor 32 or each exhaust motor 42. Further, the illumination pattern is to adjust the illuminance of each of the fluorescent lamp units 20 in accordance with the pattern of the presence or absence of a person in each section.

Since it is difficult to disclose all the control patterns that can be assumed, some typical examples will be described hereinafter.

### <Control Pattern Example (A)>

A control pattern example (A) is a control pattern in the case where a person is present in the section 1F which is located close to the center of the indoor space 1. That is, this is a control pattern when performing a cooling operation in the case where the predetermined number of people is present only in this section 1F and a setting temperature to be set in this section 1F is 26° C.

In the air-conditioning pattern of the control pattern example (A), temperatures are set in such a manner that a temperature gradient is provided in stages radially from the section 1F (specific area), regarded as the center, in which a person is present, toward the periphery. In short, with the air-conditioning pattern of the control pattern example (A), operating conditions of the air conditioners 10A to 10P are set so that the temperatures are changed in stages with two-dimensional expansion.

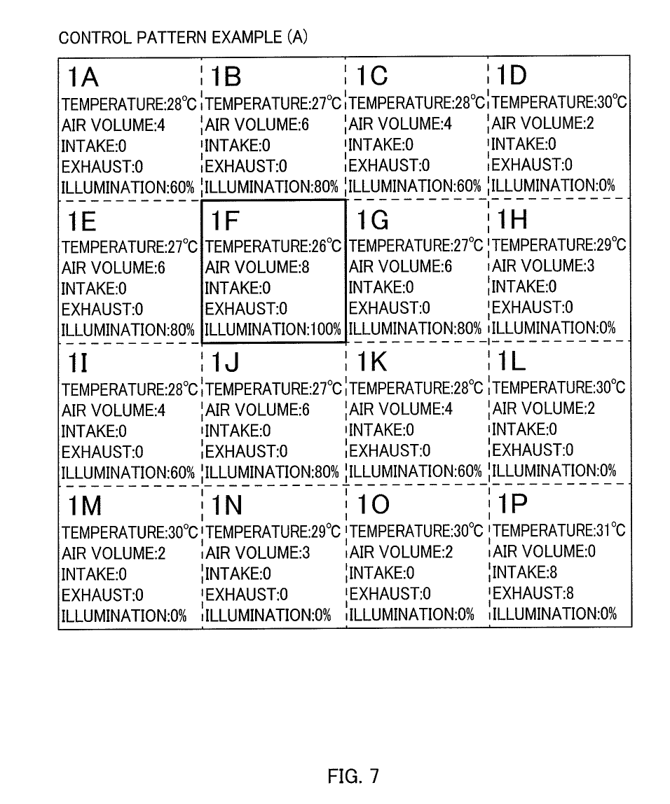

For example, as shown in FIG. 7, assuming that the air conditioner 10F in the section 1F is set at a temperature of 26° C. and at an air volume of [8] in 10 stages, each of the air conditioners 10B, 10E, 10G and 10J in the sections 1B, 1E, 1G, and 1J adjacent to the section 1F in the up-and-down and left-and-right directions in the figure is set at a temperature of 27° C., which is higher by 1° C., and at an air volume of [6], which is smaller by two stages. Also, each of the air conditioners 10A, 10C, 10I, and 10K in the sections 1A, 1C, 1I, and 1K adjacent to the section 1F in the diagonal direction, is set at a temperature of 28° C., which is higher by 2° C., and the at an air volume of [4], which is smaller by 4 stages. The same applies to the air conditioners 10 in other sections, and setting is made such that the farther the section is located from the section 1F, the higher the temperature thereof becomes as well as the smaller the air volume thereof becomes.

Setting is made such that the intake of the outside air and the exhaust of the indoor air are performed only by the intake device 30 and the exhaust device 40 of the section 1P, which is located farthest from the section 1F. To be more specific, the intake amount and the exhaust amount of the inlet 31P and the outlet 41P in the section 1P are set at [8] in 10 stages, while the intake amounts and the exhaust amounts of the inlets 31A to 31O and the outlets 41A to 41O in other sections 1A to 1O are set at [0]. The intake amount and the exhaust amount of the inlet 31P are determined in accordance with the number of people obtained from the determination of the number of people who are present in the section 1F. Therefore, if the number of people is increased, the intake amount and the exhaust amount thereof are set at [9] or [10], while if the number of people is decreased, the intake amount and the exhaust amount thereof are set at [5] or [6].

The illumination of the fluorescent lamp units 20 is controlled so that, in the section 1F and the sections 1A to 1C, 1E, 1G, and 1I to 1K adjacent to the section 1F, the corresponding fluorescent lamp units 20A to 20C, 20E, 20F, 20G, and 20I to 20K are lighted, while the fluorescent lamp units 20 in other sections are not lighted. To be more specific, the fluorescent lamp unit 20F in the section 1F is set at 100%, which is the brightest, while the fluorescent lamp units 20B, 20E, 20G, and 20J in the sections 1B, 1E, 1G, and 1J are set at 80%, which is darker than the fluorescent lamp unit 20F by 20%. Also, the fluorescent lamp units 20A, 20C, 20I, and 20K in the sections 1A, 1C, 1I, and 1K are set at 60%, which is darker than the fluorescent lamp unit 20F by 40%.

### <Control Pattern Example (B)>

A control pattern example (B) is also a control pattern of a case where a person is present in the section 1F. To be more specific, this is a control pattern when a heating operation is performed in a case where the predetermined number of people are present only in this section 1F, and a setting temperature of this section 1F is 24° C. In the control pattern example (B) as well, temperatures are set in such a manner that a temperature gradient is provided in stages radially from the section 1F regarded as the center, in which a person is present, toward the periphery. However, in the control pattern example (B), since this is a control pattern when the heating operation is performed, the air conditioner 10 in the section 1F is set at the highest temperature and air volume, and the farther the section is located from the section 1F, the lower the temperature and air volume thereof are set at.

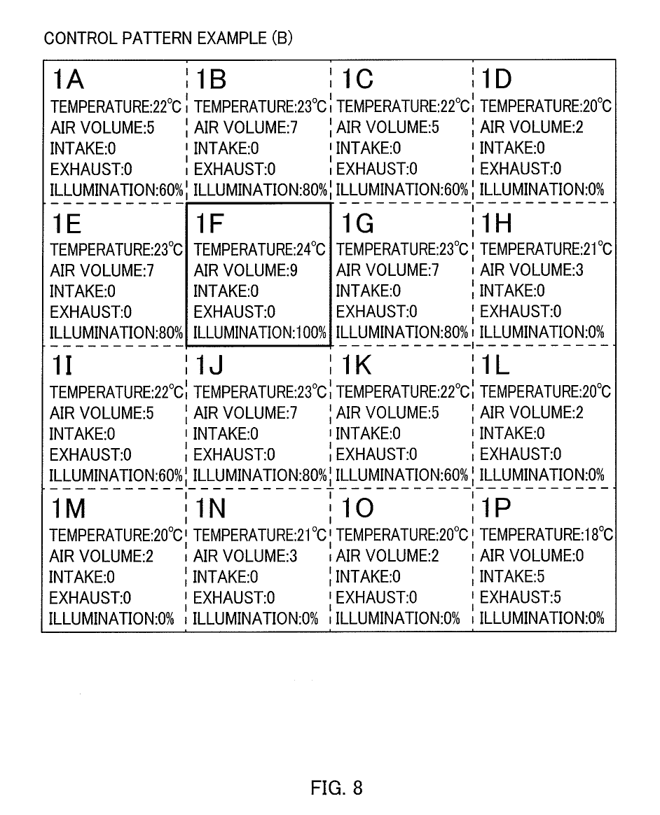

As shown in FIG. 8, assuming that the air conditioner 10 in the section 1F is set at a temperature of 24° C. and an air volume of [9], each of the air conditioners 10 in the sections 1B, 1E, 1G, and 1J, are set at a temperature of 23° C., which is lower by 1° C., and at an air volume of [7], which is smaller by two stages. Also, the air conditioners 10 in the sections 1A, 1C, 1I, and 1K are set at a temperature of 22° C., which is lower by 2° C., and at an air volume of [5], which is smaller by four stages.

Setting is made such that the intake of the outside air and the exhaust of the indoor air are performed only by the intake device 30 and the exhaust device 40 of the section 1P, which is located farthest from the section 1F. To be more specific, the intake amount and the exhaust amount of the inlet 31P and the outlet 41P in the section 1P are set at [5], while the intake amounts and the air exhaust amounts of the inlets 31 and the outlets 41 of other sections are set at [0]. Here, in the control pattern example (A), the intake amount and the air exhaust amount are set at [8]. Such a difference is caused by the fact that the number of people in the section 1F in the control pattern example (B) is smaller than the number of people in the section 1F in the control pattern example (A).

Since there is no difference in the illumination by the fluorescent lamp units 20 between the control pattern example

(B) and the control pattern example (A), the description will be omitted.

### <Control Pattern Example (C)>

A control pattern example (C) is a control pattern of a case where a person is present in the section 1M located at a corner portion of the indoor space 1. To be more specific, this is a control pattern when a cooling operation is performed in which the predetermined number of people are present only in the section 1M and a setting temperature of the air conditioner 10M in the section 1M is 26° C. In the control pattern example (C) as well, temperatures are set in such a manner that a temperature gradient is provided in stages radially from the section 1M regarded as the center, in which a person is present, toward the periphery.

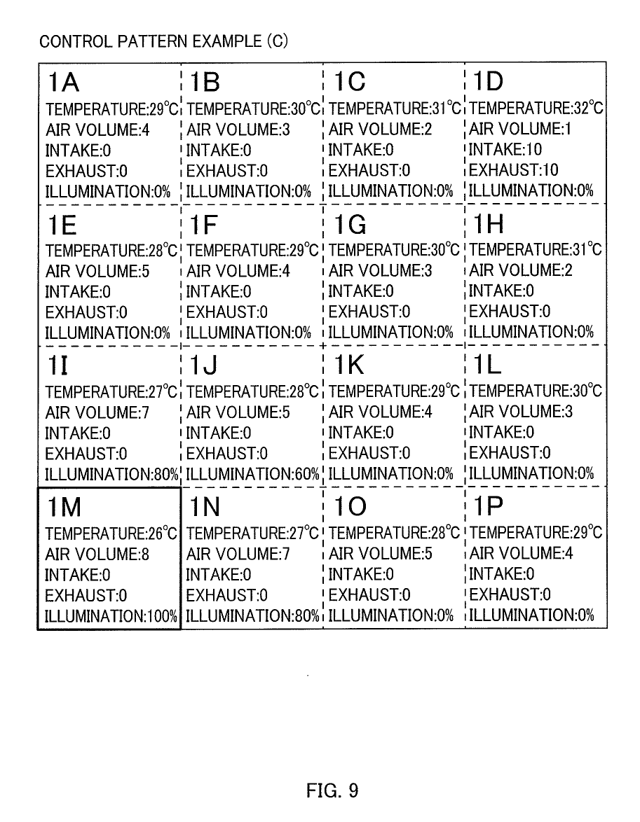

As shown in FIG. 9, assuming that the air conditioner 10M in the section 1M is set at a temperature of 26° C. and an air volume of [8], the air conditioners 10I and 10N in the sections 1I and 1N are set at a temperature of 27° C., which is higher by 1° C., and at an air volume of [7], which is smaller by one stage. Also, the air conditioners 10E, 10J, and 10O in the sections 1E, 1J, and 1O are set at a temperature of 28° C., which is higher by 2° C., and at an air volume of [5], which is smaller by three stages. As for the other air conditioners 10 as well, setting is made such that the farther the section is located from the section 1F, the higher the temperature thereof becomes as well as the smaller the air volume thereof becomes.

Setting is made such that the intake of the outside air and the exhaust of the indoor air are performed only by the intake device 30 and the exhaust device 40 of the section 1D, which is located farthest from the section 1M. To be more specific, the intake amount and the air exhaust amount of the inlet 31D and the outlet 41D in the section 1D are set at [10], while the intake amounts and the air exhaust amounts of the inlets 31 and the outlets 41 in other sections are set at [0]. In the control pattern example (A), the intake amount and the air exhaust amount of the inlet 31P and the outlet 41P are set at [8]. Such a difference is caused by the fact that the number of people in the section 1M in the control pattern example (C) is greater than the number of people in the section 1F in the control pattern example (A).

The illumination of the fluorescent lamp units 20 is controlled so that, in the section 1M and the sections 1I, 1J, and 1N adjacent to the section 1M, the corresponding fluorescent lamp units 20I, 20J, 20M, and 20N are lighted, while other fluorescent lamp units 20 are not lighted. To be more specific, the fluorescent lamp unit 20M in the section 1M is set at 100%, which is the brightest, while the fluorescent lamp units 20I and 20N in the sections 1I and 1N are set at 80%, which is darker than the fluorescent lamp unit 20M by 20%. Also, the fluorescent lamp unit 20J in the section 1J is set at 60%, which is darker than the fluorescent lamp unit 20M by 40%.

### <Control Pattern Example (D)>

The above-described control patterns (A) to (C) are control patterns if a person is detected in one section, but a control pattern example (D) is a control pattern if a person is detected in each of two sections. To be more specific, a diagram illustrates a control pattern when the cooling operation is performed, if a person is present in each of the sections 1E and 1O. In the control pattern example (D), a position of the center of gravity (a position of the center of gravity of a plane figure based on the distribution of people) in the indoor space 1 is obtained and the section 1 corresponding to the position of the center of gravity is used as the center, so that temperatures of the air conditioners 10A to 10P are set in such a manner that a temperature gradient is provided in stages radially from the section 1 toward the periphery.

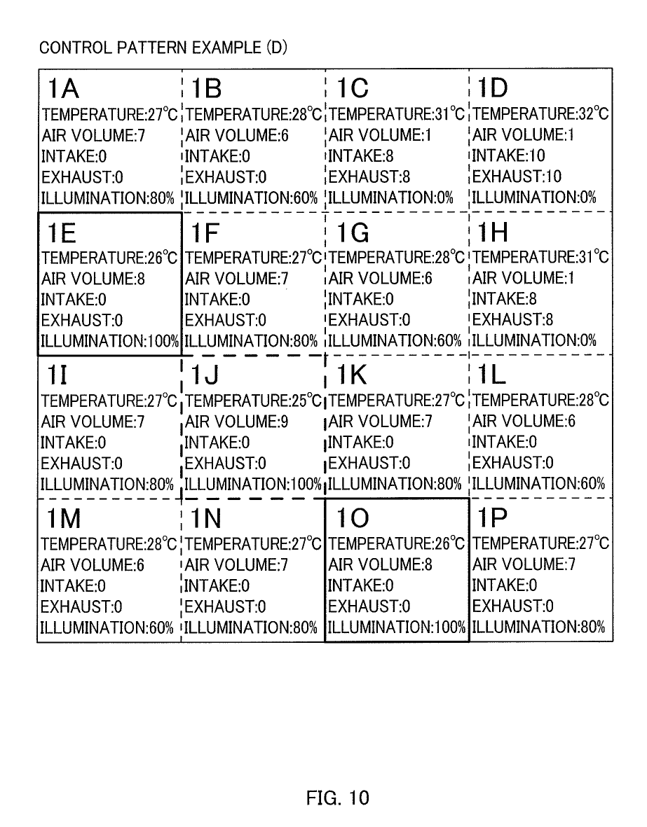

As shown in FIG. 10, in the control pattern example (D), since a person is detected in each of the section 1E and the section 10, the center of gravity is positioned in the section 1J which is located between the section 1E and the section 1O. Thus, with this section 1J being used as the center, the temperatures of the air conditioners 10A to 10P are set in such a manner that a temperature gradient is provided in stages radially from the section 1J.

In the control pattern example (D), each of the air conditioners 10E and 10O of the section 1E and the section 1O is set at a temperature of 26° C. and an air volume at [8]. In this case, the air conditioner 10J of the section 1J, which is used as the center, is set at a temperature lower than those of the section 1E and the section 1O, and at an air volume greater than those thereof, considering that the cooling operation is performed. For example, it is set at a temperature of 25° C. and at an air volume of [9]. Then, the air conditioners 10 of other sections 1 are set such that the farther the section is located from the section 1J, the lower the temperature thereof becomes as well as the smaller the air volume thereof becomes. For example, the air conditioners 10I and 10N in the sections 1I and 1N are set at a temperature of 27° C. and an air volume of [7]. Also, the air conditioners 10A, 10F, 10K, and 10P of the sections 1A, 1F, 1K, and 1P are set at a temperature of 27° C. and an air volume of [7]. Also, the air conditioners 10M, 10B, 10G, and 10L of the sections 1M, 1B, 1G, and 1L are set at a temperature of 28° C. and an air volume of [6].

Setting is made such that the intake of the outside air and the exhaust of the indoor air are performed in the three sections 1C, 1D, and 1H located far from the section 1J. The intake amount and the exhaust amount of the inlet 31D and the outlet 41D in the farthest section 1D are set at [10], and the intake amounts and the exhaust amounts of the inlets 31C and 31H and the outlets 41C and 41H in the section 1C and the section 1H, which are second farthest, are set at [8]. To be more specific, setting is made such that the farther the section is located from the section 1J, the greater the intake amount and the air exhaust amount thereof become.

As for illumination by the fluorescent lamp units 20, the fluorescent lamp units 20E, 20J, and 20O of the three sections, i.e., the sections 1E, 1J, and 1O, are set at 100%, which is the brightest. Accordingly, the fluorescent lamp units 20 to be set at brightness of 80% and the fluorescent lamp units 20 to be set at brightness of 60% are increased. To be more specific, the fluorescent lamp units 20A, 20F, 20K, 20P, 201, and 20N corresponding to the sections 1A, 1F, 1K, 1P, 1I, and 1N are set at 80%. The fluorescent lamp units 20B, 20G, 20L, and 20M of the sections 1B, 1G, 1L, and 1M are set at 60%.

### <Control Pattern Example (E)>

A control pattern example (E) is also a control pattern if a person is detected in each of two sections. The control pattern example (E) is different from the above-described control pattern (D) in such a respect that the air conditioners 10 are different in setting among the sections in which people are detected.

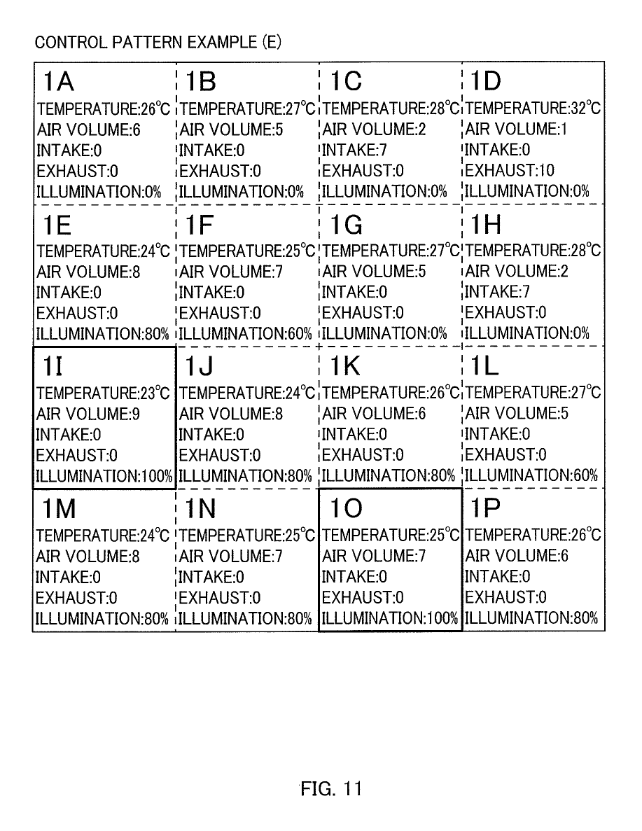

As shown in FIG. 11, the control pattern example (E) is a control pattern when the cooling operation is performed, if a person is present in each of the section 1I and the section 1O. In the control pattern example (E), the air conditioner 10I in the section 1I is set at a temperature of 23° C. and an air volume of [9], and the air conditioner 100 in the section 10 is set at a temperature of 25° C. and an air volume of [7]. In this example, the section 1I and the section 1O are considered as separate centers, and the temperatures and the air volumes of the air conditioners 10 in other sections are set. The air conditioners 10 in the other sections are set at temperatures on the basis of the closer section out of the two sections which are considered as the centers. Also, for the air conditioners 10 in the sections at an equal distance from the both sections 1I and 1O, a lower temperature setting takes effect, considering that the cooling operation is performed. Therefore, the air conditioners 10A, 10B, 10E, 10F, and 10M in the sections 1A, 1B, 1E, 1F, and 1M are set at the temperatures and air volumes on the basis of the setting of the section 1I. On the other hand, the air conditioners 10D, 10G, 10H, 10K, 10L, and 10P of the sections 1D, 1G, 1H, 1K, 1L, and 1P are set at the temperatures and air volumes on the basis of the setting of the section 1O. Also, the air conditioners 10J and 10N in the sections 1J and 1N, settings on the side where the setting temperature is lower and the air volume is greater are used as a basis.

Setting is made such that the intake of the outside air and the exhaust of the indoor air are performed, in the control pattern example (E) as well, on the basis of the section 1J including the center of gravity of the section 1I and the section 1O. Therefore, the intake amount and the air exhaust amount are set so that the intake/exhaust is performed in the section 1D, which is the farthest from the section 1J. Also, as for the illumination by the fluorescent lamp units 20, settings are made assuming that there are two centers, i.e., the section 1I and the section 1O, and the brighter setting is employed for the section 1 with different settings in brightness. A detailed description of the settings of the illumination will be omitted.

### <Control Pattern Example (F)>

A control pattern example (F) is also a control pattern if a person is detected in each of two sections. In the control pattern example (F), the sections where people are detected are adjacent to each other, and the settings of the temperature and the air volume are the same therebetween.

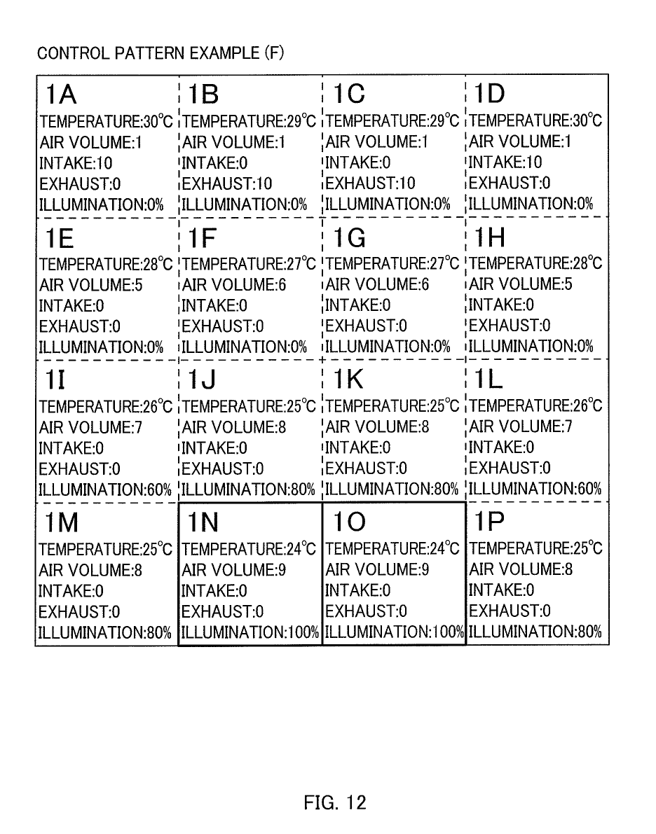

As shown in FIG. 12, the control pattern example (F) is a control pattern when the cooling operation is performed, if a person is present in each of the section 1N and the section 1O. In the control pattern example (F), the air conditioners 10N and 10O of the section 1N and the section 1O are set at a temperature of 24° C. and an air volume of [9]. In this case, considering the section 1I and the section 1O as one section 1, the temperatures and the air volumes in other sections are set.

Then, as for the intake of the outside air and the exhaust of the indoor air as well, the sections, in which the intake and the exhaust are performed, and the intake amount and the exhaust amount are set considering the section 1N and the section 1O as one section 1. In this control pattern example (F), the intake and the exhaust are performed using the intake device 30 and the exhaust device 40 provided in the section 1A to the section 1D, which are the farthest from the section 1N and the section 1O. To be more specific, the outside air is taken in through the inlets 31A and 31D of the section 1A and the section 1D, and the indoor air is exhausted through the outlets 41B and 41C of the section 1B and the section 1C.

Also, illumination by the fluorescent lamp units 20 is set considering the section 1N and the section 1O as one section. A detailed description of the setting of the illumination will be omitted.

### <System Operation>

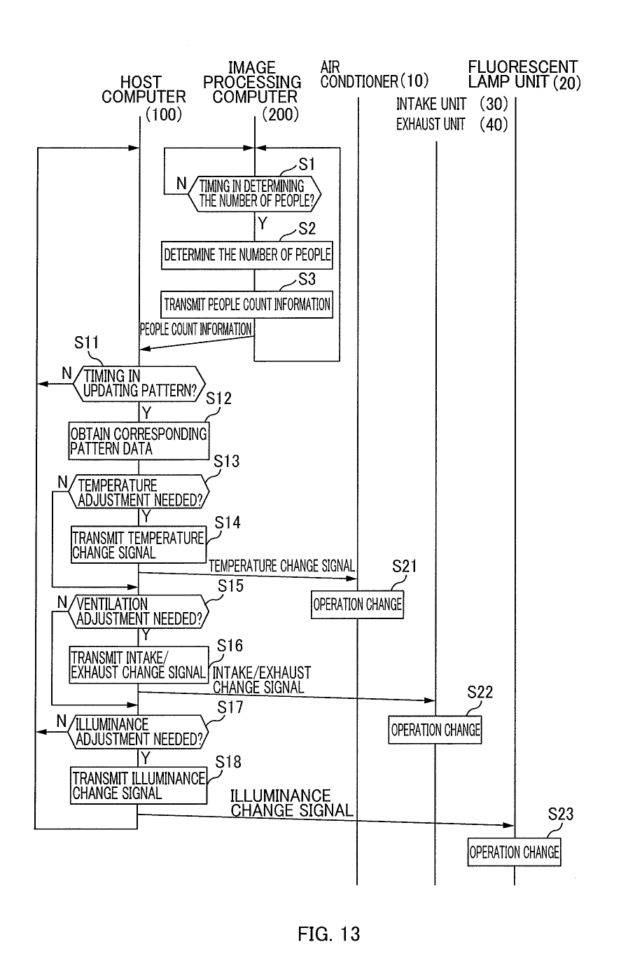

Subsequently, an operation of the electric equipment management system will be described. As shown in FIG. 13, in this system, first of all, the image processing computer 200 determines whether or not it is timing in obtaining the number of people (S1). In an embodiment of the present invention, a configuration is such that the number of people per section is obtained per minute (predetermined period). Thus, the image processing computer 200 determines whether or not one minute has elapsed since the previous timing in obtaining the number of people on the basis of the time information by the timer 220, and if it determines that the time has elapsed, go to processing in Step S2.

In Step S2, people count determination processing is performed. This determination processing is performed on the basis of the image data stored in the image data storage area 252. To be more specific, the image processing computer 200 extracts images of people on the basis of the image data, and obtains people count information indicating the number of people per section. Then, the obtained people count information is transmitted to the host computer 100 (S3). The host computer 100 receives the people count information from the image processing computer 200, and stores it in the people count information storage area 153.

The host computer 100 determines whether or not it is timing in updating the control pattern. In an embodiment of the present invention, an update period is set at 1 minute (predetermined period). Thus, the host computer 100 determines whether or not one minute has elapsed since the previous data-update timing on the basis of the time information by the timer 120, and if it determines that the time has elapsed, go to processing in Step S12.

In Step S12, data of the corresponding control pattern is obtained. In this case, the host computer 100 first reads the people count information for the past three minutes, and calculates the average number of people per section. Subsequently, the host computer 100 recognizes a section with a person, in which a person is detected, and a section without a person, in which a person is not detected. Further, in the section with a person, it determines the number of people per section. Thereafter, the host computer 100 selects the most suitable control pattern in accordance with the arrangement pattern of the section with a person and the section without a person, and the number of people who are present in the indoor space 1, and reads the pattern from the air-conditioning pattern storage area 155, the ventilation pattern storage area 156, and the illumination pattern storage area 157.

Once the corresponding control pattern has been read, the host computer 100 determines whether or not temperature adjustment is needed for the air conditioners 10 (S13). For example, the control pattern having been used so far is compared with the newly-read control pattern in each section. Then, if there is a difference in setting temperature or air volume, a temperature change signal is transmitted to the air conditioner provided in the section 1 (S14). The air conditioner 10 having received this temperature change signal updates the setting temperature information stored in the setting temperature information storage area 14c to the one indicated by the temperature change signal (S21). As a result, the setting temperature and/or air volume in this air conditioner 10 is changed.

Subsequently, the host computer 100 determines whether or not adjustment is needed for the intake device 30 and/or the exhaust device 40 (S15). Here again, the control pattern having been used so far is compared with the newly-read control pattern in each section, and it is determined whether or not there is a difference in intake amount and/or air exhaust amount. If there is a difference, an intake/exhaust change signal is transmitted to the intake device 30 or the exhaust device 40 provided in the section 1 (S16). Then, the intake device 30 and/or the exhaust device 40 having received the intake/exhaust change signal changes the rotation speed of the intake motor 32 or the exhaust motor 42 (S22). As a result, the intake amount or the exhaust amount in the target inlet 31 or outlet 41 is changed.

Subsequently, the host computer 100 determines whether or not illuminance adjustment is needed for the fluorescent lamp units 20 (S17). Here again, the control pattern having been used so far is compared with the newly-read control pattern in each section, and it is determined whether or not there is a difference in illuminance. If there is a difference, an illuminance change signal is transmitted to the fluorescent lamp unit 20 provided in the section 1 (S18). The air conditioner 10 having received this illuminance change signal updates the illuminance information stored in the illuminance information storage area 24c to the one indicated by the illuminance change signal (S23). As a result, the brightness in the fluorescent lamp unit 20 is changed. Thereafter, the above-described processing is performed repeatedly.

### <Summary>

As described above, in the electric equipment management system according to an embodiment of the present invention, the indoor space 1 is virtually divided into the plurality of sections 1A to 1P, and the sections 1A to 1P are respectively provided with the plurality of air conditioners 10A to 10P for causing the sections 1A to 1P to become at desired temperature, respectively. This system includes the group of the camera 50 and the image processing computer 200 for detecting the presence or absence of a person per section, and the host computer 100 connected to the image processing computer 200 in such a manner as to be capable of communication therebetween. In the memory 150 included in the host computer 100, the air-conditioning patterns for adjusting the setting temperature in each of the plurality of air conditioners 10 are stored in a plurality of types each in accordance with the pattern of the presence or absence of a person in each section, and the host computer 100 selects a air-conditioning pattern of the pattern corresponding to the detection result of the image processing computer 200 among the air-conditioning patterns of a plurality of types, and adjusts the setting temperatures of the plurality of air conditioners 10A to 10P in accordance with the selected air-conditioning pattern.

This electric equipment management system is configured such that the air-conditioning pattern is selected in accordance with the pattern of the presence or absence of a person in each section and the plurality of air conditioners 10 are controlled by the selected air-conditioning pattern, and thus, even if the control are changed due to the movement of the person or the like, it is only necessary to select the corresponding air-conditioning pattern. Therefore, the control can be changed in an efficient manner.

And the air-conditioning patterns include those used when the cooling operation is performed (data for cooling) and those used when the heating operation is performed (data for heating). Among them, the air-conditioning patterns for cooling are to make an adjustment to the setting temperature so that a section without a person, in which a person is not detected, becomes higher in temperature than a section with a person, in which a person is detected, in the plurality of sections 1A to 1P. The air-conditioning patterns for heating are to make an adjustment to the setting temperature so that the temperature in the section without a person becomes lower than the temperature in the section with a person. Since such air-conditioning patterns is used, the section with a person can be adjusted to a desired temperature, while in the sections without a person, the energy saving operation of the air conditioners 10 is made possible.

Further, the air-conditioning patterns to be used when the cooling operation is performed is to an make adjustment to the setting temperature so that the farther the section without a person is located from the section with a person, the higher the temperature thereof becomes, and the air-conditioning patterns to be used when the heating operation is performed is to make an adjustment to the setting temperature so that the farther the section without a person is located from the section with a person, the lower the temperature thereof becomes, and thus, such temperature distribution can be realized as to expand in the planar direction with the section with a person being as the center. As a result, the plurality of air conditioners 10A to 10P are operated, so that such a malfunction that a part of the air conditioners 10 is under a heavy loaded condition can be suppressed. Since the plurality of air conditioners 10A to 10P are operated as such, each of the air conditioners 10A to 10P can be operated with an intermediate output power. In this type of air conditioners 10, the cooling/heating efficiency thereof is usually higher with the intermediate output than that with the maximum output power. Thus, all of the air conditioners are operated with the intermediate output power, so that the energy saving operation can be realized as a result.

Further, the electric equipment management system according to an embodiment of the present invention is provided with the intake device 30 that takes the outside air into the indoor space 1. The intake device 30 includes the inlets 31, arranged at different spots in the indoor space 1, each of which is capable of changing the amount of the outside air that is to be taken into spaces to be air-conditioned. On the other hand, the memory 150 included in the host computer 100 stores ventilation patterns (intake amount data) which have a plurality of types each in accordance with the pattern of the presence or absence of a person in each section and which set the intake amount of the outside air in each of the plurality of inlets 31, so that the host computer 100 selects the ventilation pattern of the pattern corresponding to the detection result in the image processing computer 200 from among the plurality of types of the ventilation patterns, and adjusts the amount of the outside air to be taken in through each of the plurality of inlets 31 in accordance with the selected ventilation pattern. The intake control of the outside air is executed using this type of ventilation pattern, so that an appropriate amount of the outside air can be taken in.

Further, the ventilation pattern is to adjust the intake amount of the outside air so that the amount of the outside air to be taken in through the inlet 31 located farther from the section with a person, in which a person is detected, becomes greater than the amount of the outside air to be taken in through the inlet 31 closer to the section with a person, in the plurality of sections 1A to 1P. As a result, the appropriate amount of the outside air can be taken in without losing the cooling/heating efficiency of the air conditioners 10. Particularly, if adjustment is made so that the outside air is taken in only through the inlet 31 located farthest from the section with a person, the decrease in the cooling/heating efficiency caused by the intake of the outside air can be reliably suppressed.

The intake has been described above, but the similar effects can also be achieved for the exhaust.

### OTHER EMBODIMENTS

The above embodiments of the present invention are simply for facilitating the understanding of the present invention and are not in any way to be construed as limiting the present invention. The present invention may variously be changed or altered without departing from its spirit and encompass equivalents thereof.

With regard to the sections, the rectangular sections 1A to 1P divided in the horizontal direction in a grid manner are exemplified in an embodiment described above, however, a shape of the sections is not limited to a rectangular shape. For example, it may be a hexagonal shape or a triangular shape. In short, it is only necessary that the sections are divided in the planar direction.

With regard to the detection of a person in each section, when only the presence or absence of a person is to be detected, other detecting means such as an infrared sensor may be used. Here, if a person is detected in each section by the camera 50 and the image processing computer 200 as in an embodiment of the present invention, the number of people in each section can also be determined, so that precise control in consideration of the number of people can be executed. Updating cycles of the people detection timing and the control pattern can be set as appropriate.

With regard to the control pattern, in an embodiment described above, the control patterns (C) to (F) are intended for the cooling operation, but they can also be used as the control pattern for the heating operation. In this case, as in the relationship between the control patterns (A) and (B), it is only necessary to set the control pattern such that the closer to the periphery the section is located, the lower the temperature thereof becomes in stages.

With regard to the setting temperature in the control pattern, upper/lower limit (during cooling/heating operation) may be set. To be more specific, the temperature is set so as not to exceed the upper limit temperature during the cooling operation, while the temperature is set so as not to fall under the lower limit temperature during the heating operation. Such upper/lower limit may be a fixed value or may be determined in accordance with the temperature of the outside air. If it is set in accordance with the temperature of the outside air, it is determined such that the upper limit temperature is lower than the outside air temperature during the cooling operation, while the lower limit temperature is higher than the outside air temperature during the heating operation.

With regard to the fluorescent lamp units 20, an intended unit does not have to be a fluorescent lamp. It may be other light sources as long as a light control function capable of controlling brightness is provided therein. For example, it may be an LED light or an incandescent lamp.

With regard to the intake device 30 and the exhaust device 40, the inlet 31 and the outlet 41 do not have to be provided in each section. For example, they may be provided on a surface of a wall of the indoor space 1. In short, it is only necessary that a plurality of lamps are arranged at different positions in the indoor space 1.

What is claimed is:

1. An air-conditioning control apparatus of an air-conditioning system including a plurality of air conditioners respectively provided in a plurality of sections obtained by virtually dividing a space to be air-conditioned, the plurality of air conditioners configured to set the plurality of sections at desired temperatures, respectively, the air-conditioning control apparatus comprising:
a people detection unit configured to detect presence or absence of a person in each of the plurality of sections;
a memory configured to store temperature adjustment data for adjusting a setting temperature in each of the plurality of air conditioners, the temperature adjustment data being of a plurality of types each in accordance with a pattern of presence or absence of a person in each of the plurality of sections; and
an adjustment unit configured to select the temperature adjustment data of a pattern corresponding to a detection result of the people detection unit from among the temperature adjustment data of a plurality of types, and adjust the setting temperature of each of the plurality of air conditioners in accordance with the selected temperature adjustment data.

2. The air-conditioning control apparatus according to claim 1, wherein
the temperature adjustment data includes: data for cooling for adjusting the setting temperature so that a section without a person, in which a person is not detected, becomes higher in temperature than a section with a person, in which a person is detected, in the plurality of sections; and data for heating for adjusting the setting temperature so that the section without a person becomes lower in temperature than the section with a person.

3. The air-conditioning control apparatus according to claim 2, wherein
the data for cooling includes data for adjusting the setting temperature so that the farther the section without a person is located from the section with a person, the higher a temperature of the section without a person becomes, and wherein
the data for heating includes data for adjusting the setting temperature so that the farther the section without a person is located from the section with a person, the lower a temperature of the section without a person becomes.

4. The air-conditioning control apparatus according to claim 1, wherein
the air-conditioning system includes intake devices arranged at different spots in the space to be air-conditioned, the intake devices configured to take outside air into the space to be air-conditioned through a plurality of inlets each capable of changing an amount of the outside air to be taken into the space to be air-conditioned, wherein
the memory stores intake amount data for setting an intake amount of the outside air in each of the plurality of inlets, the intake amount data being of a plurality of types each in accordance with a pattern of presence or absence of a person in each of the plurality of sections, and wherein
the adjustment unit selects the intake amount data of a pattern corresponding to a detection result of the people detection unit from among the intake amount data of a plurality of types, and adjusts an amount of the outside air to be taken in through each of the plurality of inlets in accordance with the selected intake amount data.

5. The air-conditioning control apparatus according to claim 4, wherein
the intake amount data includes data for making such an adjustment that the outside air to be taken in through an inlet located farther from a section with a person, at which a person is detected, in the plurality of sections becomes greater in amount than the outside air to be taken through an inlet located closer to the section with a person.

6. The air-conditioning control apparatus according to claim 5, wherein
the intake amount data includes data for making such an adjustment that the outside air is taken in only through an inlet located farthest from the section with a person.
